(19) United States
(12) Patent Application Publication
(10) Pub. No.: US 2011/0010383 A1
(43) Pub. Date: Jan. 13, 2011

(54) SYSTEMS AND METHODS FOR STREAMLINING OVER-THE-AIR AND OVER-THE-WIRE DEVICE MANAGEMENT

(76) Inventors: Peter C. THOMPSON, San Diego, CA (US); Laurence G. LUNDBLADE, San Diego, CA (US)

Correspondence Address: QUALCOMM INCORPORATED, 5775 MOREHOUSE DR., SAN DIEGO, CA, 92121, US

(21) Appl. No.: 12/551,561

(22) Filed: Aug. 31, 2009

Related U.S. Application Data
(60) Provisional application No. 61/223,635, filed on Jul. 7, 2009.

(51) Int. Cl. G06F 15/16; G06F 15/177; G06F 17/30

(52) U.S. Cl. 707/769; 709/227; 709/221; 707/802; 709/224; 709/203; 707/E17.005; 707/E17.044; 707/E17.014

(57) ABSTRACT

Methods and systems streamline remote device management by eliminating the need to download device configuration data when no configuration changes have been made since the last device management session. A device may record data enabling it to determine whether configurations have changed since a last session with a device management server. Device management servers may record configurations of devices. While initiating a device management session, a device can inform the device management server whether an intervening configuration change has occurred. If no intervening configuration changes have occurred, the device management server can forgo obtaining the device's configuration data, saving communication time and bandwidth. If an intervening configuration change has occurred, the remote device may inform the server of the URI of the changed configuration item, enabling the server to request download of just the changed item. Alternatively, the remote device may provide changed configuration data to the device management server.

### RELATED APPLICATIONS

This application claims the benefit of priority to U.S. Provisional Patent Application No. 61/223,635 entitled “Systems and Methods for Streamlining Over-The-Air and Over-The-Wire Device Management” filed Jul. 7, 2009, the entire contents of which are hereby incorporated by reference.

### FIELD OF THE INVENTION

The present invention relates generally to computer networks, and more particularly to methods and systems for accomplishing over-the-air and over-the-wire management of computing devices.

### BACKGROUND

The Open Mobile Alliance (OMA) has issued a Device Management (DM) technical specification which standardizes methods, messaging formats and commands for managing devices remotely, such as via over-the-air or over-the-wire communication links. The term device management refers to managing device configurations, provisioning client applications, and detecting problems of remote devices from servers.

### SUMMARY

Methods and systems enable streamlining remote device management by eliminating the need for device management servers to download device configuration data from remote computing devices when no changes have been made to device configuration data since the last device management session with the server. A computing device may record data enabling it to determine whether configuration data has been changed since the last update session with a device management server. Device management servers may record configuration data of computing devices with which they perform update services. While initiating a device management session, a computing device can inform the device management server whether an intervening configuration data change has occurred. If no intervening configuration data changes have occurred, the device management server can forgo commanding the computing device to download its configuration data, thereby saving communication time and bandwidth. In an alternative embodiment, the remote computing device may send to the device management server the URI of the item that has been changed since the last update session with the server, enabling the server to request download of just the changed item. In a further alternative embodiment, the remote computing device may provide to the device management server the configuration data that changed since the last update session with the server.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating a communication system suitable for use with the various embodiments.

FIG. 2 is a communication system block diagram illustrating components in communication with a mobile device for use with various embodiments.

FIG. 3 is a process flow diagram of an overview of the various embodiments.

FIG. 4 is a process flow diagram of an embodiment method for initiating a device management session from a remote device.

FIG. 5 is a process flow diagram of an embodiment method for conducting a device management session from a server.

FIG. 6 is a process flow diagram of another embodiment method for initiating a device management session from a remote device.

FIG. 7 is a process flow diagram of another embodiment method for conducting a device management session from a server.

FIG. 8 is a process flow diagram of another embodiment method for initiating a device management session from a remote device.

FIG. 9 is a process flow diagram of another embodiment method for conducting a device management session from a server.

FIGS. 10A-10B are data structure diagrams of example data structures suitable for recording interactions with device management servers.

FIGS. 11A-11B are data structure diagrams of example data structures suitable for recording information regarding configuration updates.

FIG. 12 is a data structure diagram of an example device configuration database suitable for implementation on servers that manage remote devices.

FIG. 13 is a data model illustration of an example device management tree.

FIG. 14 is a component block diagram of a mobile device suitable for use with various embodiments.

FIG. 15 is a component block diagram of a server suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “remote device” refers to any of a variety of programmable computing devices which are configured to receive device management updates from remote servers, and may include personal computers and mobile devices. As used herein, the terms “mobile device” refers to any one or all of cellular telephones, personal data assistants (PDA's), palm-top computers, wireless electronic mail receivers, multimedia Internet enabled cellular telephones, Global Positioning System (GPS) receivers, wireless gaming controllers, and similar personal electronic devices which include a programmable processor and memory and a transceiver for communicating with a wireless communication network.

As used herein, the terms “computer,” “personal computer” and “computing device” refer to any programmable computer system that is known or that will be developed in the future. In a preferred embodiment a computer will be coupled to a network such as described herein. A computer system may be configured with software instructions to perform the processes described herein.

The various embodiments described herein provide methods and systems that enable streamlining the process for performing device management on remote devices from device management servers. The processes, protocols and data structures specified in the OMA DM technical specifications provide great flexibility in enabling a server to remotely manage the configuration of remote devices. However, if the pending device management task depends upon the particular configuration implemented within a remote device, the device management server must command the remote device to transmit its configuration data to the server before the management processes can begin. Such downloading of configuration data can require a significant amount of time for mobile devices. Yet, configuration changes may occur infrequently. Further, changes to configuration data for some applications may have no impact on device management of other applications or the particular update that is to be made. The various embodiments enabled bypassing the step of downloading configuration data when no changes in device configuration data have occurred since the last time the device management server communicated with the remote device.

To determine whether intervening configuration data changes have occurred, devices may maintain data records in memory whenever a device management session occurs with a particular device management server. Such data may be stored in the form of a data table or database within computing device memory. When a computing device engages in a device management session with a device management server, the computing device may record the current configuration update count in a data record associated with the particular device management server. Alternatively, the device may record the time and date of the device management session in a data record corresponding to the server. The next time that the computing device initiates a device management session with the same device management server, the computing device uses the stored data to determine whether a configuration change has occurred since the last session with the server. This may be accomplished by determining whether the current configuration update count is different from the update count stored in the data record associated with the particular device management server. Alternatively, this may be accomplished by determining whether the time and date of the last configuration update is different from the time and date stored in a data record corresponding to the particular device management server (e.g., a data record recording the time and date of the last session with the server).

If the computing device determines that no intervening configuration change has occurred, it provides that information to the device management server (e.g., in the form of an alert command) as part of the session initiation communications. If the device management server receives an alert from the remote device that no intervening changes in device configuration have occurred, the server can recall the device's configuration data from a memory record, which may be in the form of a device configuration database coupled to the server. Obtaining the computing device configuration data from a local database eliminates the need for the server to request the device to transmit its configuration data. This enables the device management server to proceed immediately to the scheduled or appropriate device management task.

In a further embodiment, the device may maintain a record of the URI of objects or items modified in each configuration update. Then, as part of the device management session initiation communications, if the device determines that an intervening configuration change has occurred, the device may send to the device management server an alert listing the URIs of each item affected by intervening configuration changes. The device management server receiving one or more URIs in an Alert embedded within a device management message from a remote computing device may determine whether changes to the configurations of items corresponding to the URIs might be relevant to the device management task to be accomplished. If configuration changes to the items corresponding to the URIs might be relevant to the pending device management task, the device management server may command the remote device to download the configuration data associated with those particular URIs, recalling other device configuration data from a device configuration database. If configuration changes to the items corresponding to the URIs would not be relevant to the pending device management task, the device management server can simply recall the configuration data it needs from a device configuration database, and proceed immediately with the pending device management tasks. Enabling the device management server to obtain device configuration data in this manner can reduce the amount of configuration data that needs to be downloaded.

In a further embodiment, the computing device may maintain a record of the configuration data changed in each configuration update. Then, if the computing device determines that an intervening configuration change has occurred, the device may send to the device management server an Alert containing the configuration data associated with the intervening configuration changes as part of the device management session initiation communications. The device management server receiving configuration data from a remote computing device may update the configuration data record associated with the remote device in a device configuration database, and use the updated configuration data to proceed with the pending device management task. If no configuration data is received from the remote computing device, the device management server may download the device's configuration from the device configuration database, and proceed with the pending device management task.

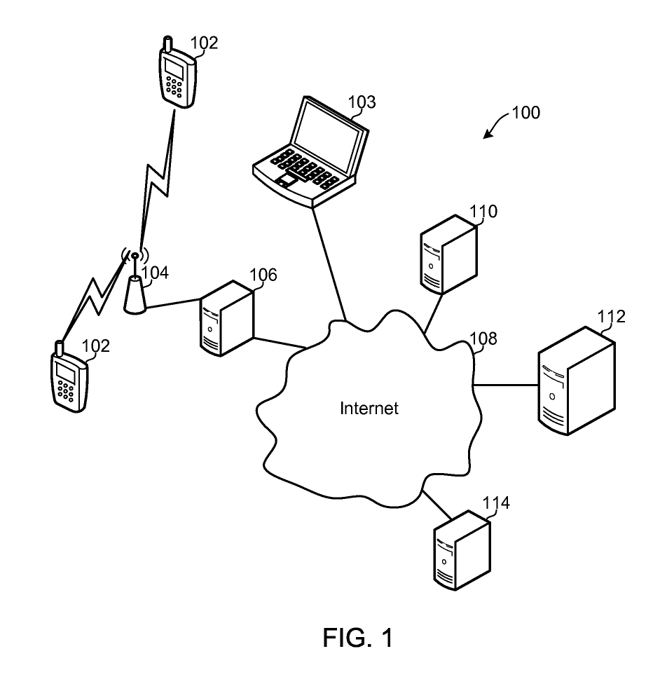

An example communication system suitable for implementing the various embodiments is illustrated in FIG. 1. Such a communication system 100 may include networked computing devices, such as mobile devices 102 and personal computers 103 with access to the Internet 108. For example, mobile devices 102, such as cellular telephones, may access the Internet via a wireless communication network 104, such as a WiFi or cellular telephone data communication network. Such wireless communication networks 104 may include a plurality of base stations coupled to a gateway or Internet access server 106 coupled to the Internet 108. Personal computers 103 may be coupled to the Internet 108 in any conventional manner, such as wired connections via an Internet gateway (as shown) or a wireless communication network 104. The communication system 100 may further include a variety of device management servers 110, 112, 114 coupled to the Internet 108. Device management servers (referred to as a “DM server” in the figures) are servers configured to perform device management updates of remote devices according to the various embodiments and the OMA DM protocol.

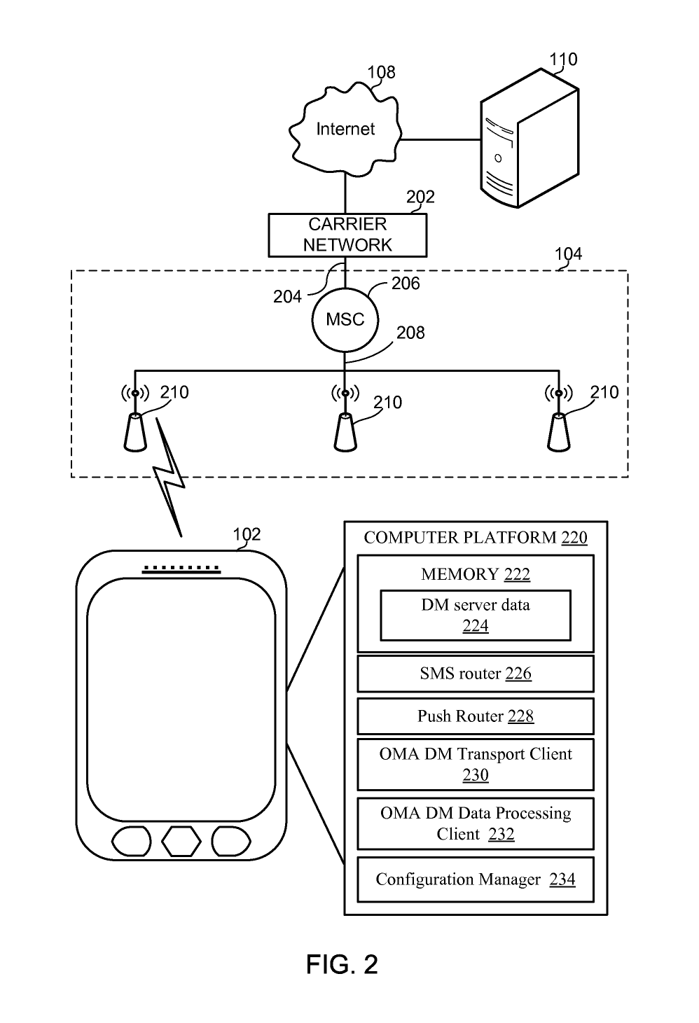

Some components of the communication system 100 that enable remote management of mobile devices 102 are illustrated in FIG. 2. The mobile device 102 may communication with a wireless network 104 to access the Internet 108 and, through the Internet, to receive remote updates from a device management server 110. The wireless network 104 may communicate with the Internet 108 via a carrier network 202 through a data link 204, which may be any known data link such as the Internet 108, a WiFi network, a secure LAN, WAN, or other network. The carrier network 202 controls messages (generally being data packets) sent to a mobile switching center (MSC) 206, and communicates with the MSC 206 to transfer data and voice information. The MSC 206 may be connected to multiple base stations (BTS) 210 by another network 208, such as a data network and/or Internet portion for data transfer and a POTS portion for voice information. A BTS 210 wirelessly broadcasts messages to and receives messages from the mobile devices 102, using predetermined voice and/or data packet services, such as Code Division Multiple Access (CDMA), short messaging service (SMS), or any other over-the-air methods.

Mobile devices 102 may be configured to include a computer platform 220 having a memory 222 in communication with a processor hosting the computer platform 220. Stored within the memory 222 may be a database 224 of device management servers with which the mobile device 102 communicates. The computer platform 220 may also include a number of software process modules used in receiving remote device management, such as a service (SMS) router 226, a push router 228, a device management transport client 230, a device management data processing client 232, a configuration manager 234, and other functional modules or components required to enable updates according to the OMA DM protocol.

While FIG. 2 illustrates the software process modules implemented within a mobile device 102, similar process modules may be implemented within other computing devices, such as personal computers 103, that are configured to engage in device management sessions with remote device management servers.

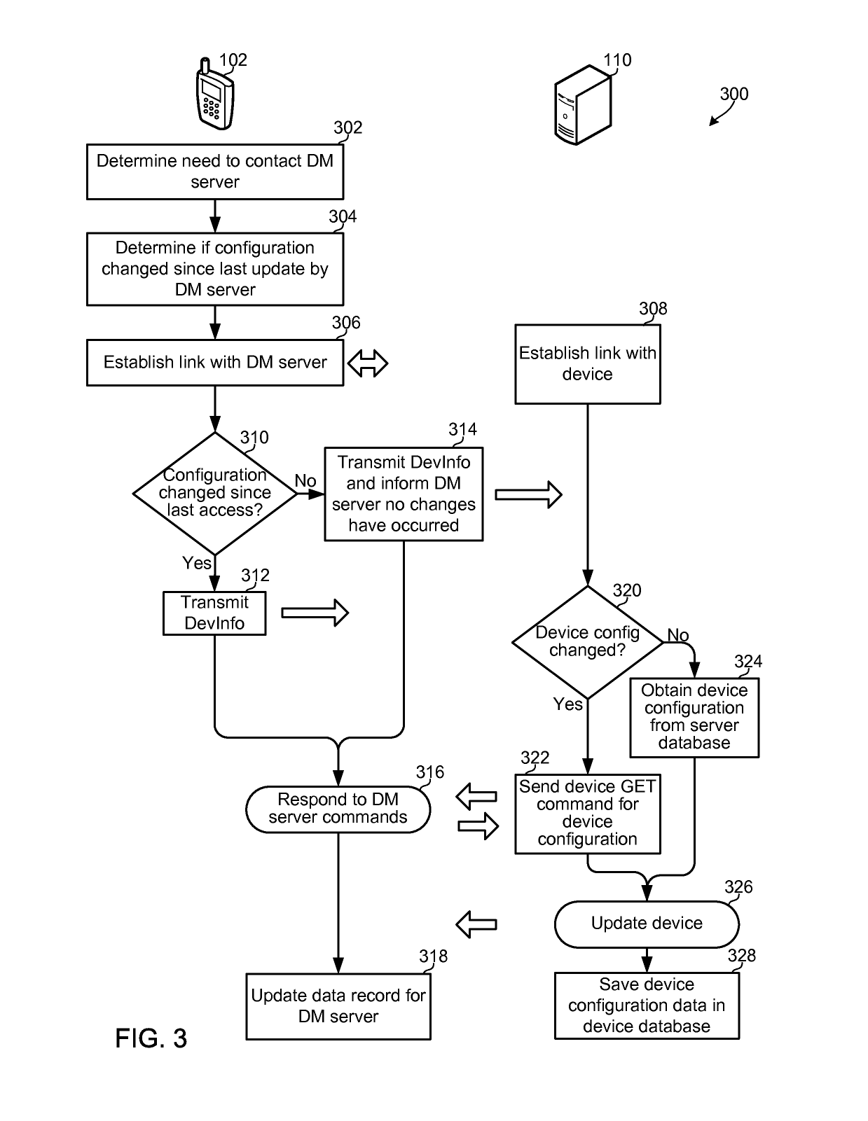

An overview of the processes involved in the various embodiments is illustrated in FIG. 3. A computing device, such as a mobile device 102, may determine a need to initiate a configuration update session with a device management server, step 302. This determination may be made based upon conditions detected within the computing device, such as a scheduled software update, new software initialization and registration, detection of new hardware requiring configuration, and the initial configuration of the computing device. The determination may also be based upon received messages, such as a WAP PUSH message that may be received from a remote device management server 110. The computing device may determine if a change in configuration data has occurred since the last communication session with the particular device management server, step 304. As described more fully below, a variety of methods may be used to make this determination based upon data that may be stored in memory of the computing device.

To initiate the device management session, the computing device establishes a communication link with the data management server, step 306, such as by making a data call to a wireless communication network and initiating an HTTPS session with the device management server. The device management server 110 receives the request to establish a data session, and then the device and server cooperate to establish the communication link, steps 306, 308.

If the computing device 102 determines that the configuration has changed since the last update by the device management server 110, that is determination 310=“Yes,” the computing device may proceed according to the OMA DM protocol by transmitting the DevInfo data to the device management server 110, step 312. The DevInfo data includes information about the computing device, such as the device ID, its hardware version, its software version, and other pertinent device-specific information. Once the DevInfo data has been transmitted, the computing device may receive and respond to device management messages from the device management server 110, such as a GET command requesting download of the device configuration data and updates according to the OMA DM protocol, step 316.

If the computing device 102 determines that the configuration data has not changed since the last update by the device management server 110, (i.e., determination 310=“No”), the computing device transmits to the device management server the DevInfo data in conjunction with an alert command indicating that no intervening configuration changes have been made, step 314. Within the OMA DM protocol, the alert command enables the remote computing device to provide information to the device management server. In this embodiment, the alert may provide a simple value or flag since the Alert need only indicate that no intervening configuration changes have been made. Once the computing device has transmitted the DevInfo data and an alert if there have been no intervening configuration changes, the computing device may receive and respond to device management messages from the device management server 110 according to the OMA DM protocol, step 316.

When the device management session is completed, the computing device updates the data record for the particular data management server that will enable the device to determine in future sessions whether there have been intervening configuration changes, step 318.

The device management server 110 receives the DevInfo data from the computing device 102, as well as the Alert if it is included, and determines from this information whether the computing device configuration has changed since the last device management session, determination 320. If the server determines that the configuration of the remote computing device has been changed since the last session with the server (i.e., determination 320=“Yes”), the device management server may obtain the device's latest configuration data by sending a GET command according to the OMA DM protocol, step 322. The computing device will respond to the GET command by transmitting its configuration data in step 316. Using the downloaded configuration data, the device management server 110 may proceed to update the computing device, step 326. Once the device update is complete, the device management server 110 may save the computing device's configuration data in a device configuration database for future reference, step 328.

If the configuration of the computing device has not been changed since the last session with the server (i.e., determination 320=“Yes”), the device management server may obtain the computing device's latest configuration data by accessing a device configuration database within or coupled to the server in order to obtain a data record containing the configuration data of the computing device, step 324. Such a device configuration database may be any form of accessible data storage coupled to the server, such as internal hard disk storage (as illustrated in FIG. 1) or external database storage accessible by the server. Using the device configuration data obtained from the device configuration database, the device management server 110 may proceed to update the remote computing device, step 326. Thus, if no intervening changes have been made to the computing device's configuration, the pending device management task can be initiated immediately without having to wait for a download of all device configuration data.

Once the device update is complete, the device management server 110 may save the computing device's configuration data in a device configuration database for future reference, step 328. The saved configuration data may include any changes made to the device's configuration as result of the device management session. If the device management session did not result in a change in device configuration data and there have been no intervening configuration changes (i.e., determination 310=“No”), the data in the device configuration database would still be accurate so there would be no need for the device management server 110 to save the device configuration data.

As mentioned above, the device management server may create and maintain the device configuration database by storing the device's configuration data at the completion of each device management session. Thus, downloaded device configuration data (i.e., data received in response to step 322) and changes to configuration data resulting from the device management session may be stored in a data record associated with the remote computing device (such as indexed to the device's identifier). This database stored in (or coupled to) the device management server will reflect the configuration of the computing device until some other process or device management server causes a configuration change.

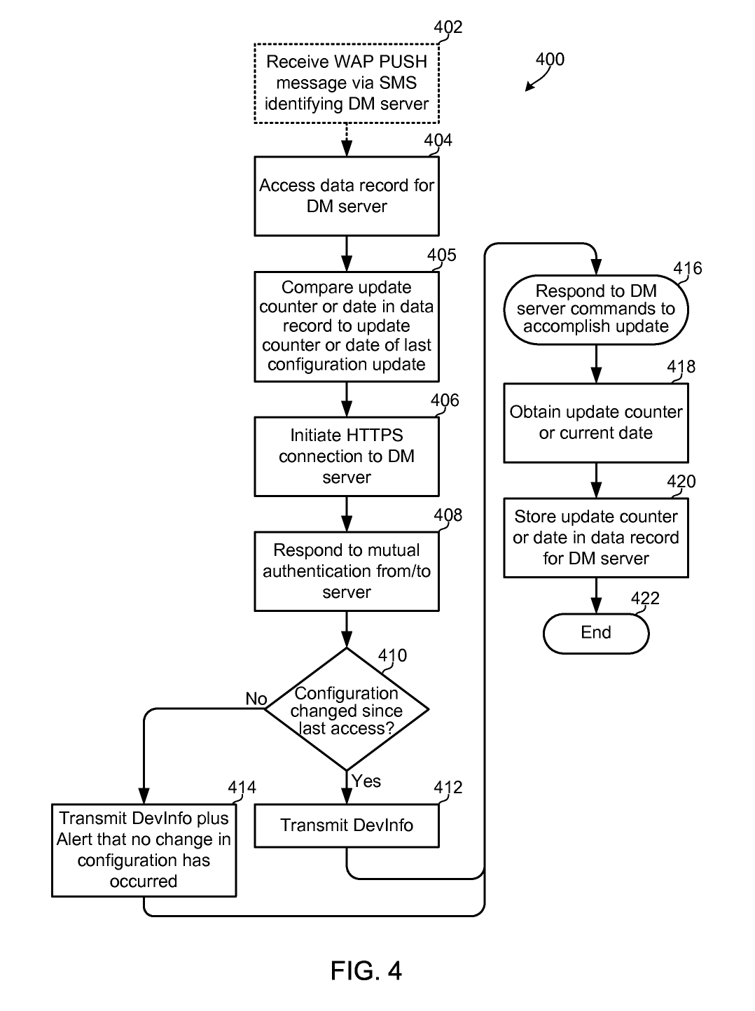

An example embodiment method 400 that may be implemented within a computing device for determining whether an intervening change has been implemented is illustrated in FIG. 4. A device management session may be initiated by a device management server transmitting a WAP PUSH message via the SMS service which will be received by the computing device, step 402. This WAP PUSH message will identify the device management server, such as the URL with which the device should establish an HTTPS connection.

Using the identifier for the device management server, the computing device may access a corresponding data record stored in its memory, step 404. The data record corresponding to the device management server may include an update counter value or the time and date of the last device management session performed with the particular server. The computing device may then compare the current update counter value or time/date in the accessed data record to the current update counter value or to a date of a last configuration update, step 405.

As is well known, computing devices may maintain a serial counter of configuration updates, which is referred to herein as the “update counter.” This update counter is incremented as each configuration update is performed on the computing device. The update counter value (or update count) may be stored in memory accessible via the device operating system or application platform. By comparing the update counter value at the time of the last communication session with the device management server to the current update counter value, the computing device can determine whether an intervening configuration change has occurred. Specifically, if the stored update counter value differs from the current update counter value, then there has been an intervening configuration change.

Another way to determine if an intervening configuration change has occurred is to compare the date of the last session with the device management server obtained from a data record in memory to the date of the last configuration change, which may be stored in another memory location. Operating system records may store the date and time of the last configuration change. This information may be obtained via the operating system or application environment and compared to the value stored in memory at the time of the last session with the data management server. If the date of the last session with the device management server is earlier than the date of the last configuration change, then there has been an intervening configuration change of the computing device.

Other mechanisms for determining whether an intervening configuration change has occurred may be implemented. For example, a database of device management server identifiers and configuration change flags may be maintained in memory of the computing device. In this embodiment, whenever a device management server makes a change to configuration data, a flag in the data record associated with that server may be reset (e.g., set to “0”) while flags in data records associated with all other device management servers are set (e.g., set to “1”) indicating that an intervening configuration change has occurred. The computing device can then determine whether an intervening configuration change has occurred simply by checking the flag in the data record associated with the particular device management server.

To initiate the device management session the computing device may initiate an HTTPS connection to the device management server, step 406, as well as send and respond to mutual authentication messages to/from the device management server, step 408.

Before or after establishing the HTTPS connection to the device management server, the computing device determines the type of initial information to send to the server based upon whether an intervening configuration change occurred, determination 410. If an intervening configuration change has occurred (i.e., determination 410=“Yes”), the computing device transmits the DevInfo data per the OMA DM protocol, step 412. On the other hand, if an intervening configuration change has not occurred (i.e., determination 410=“No”), the computing device may transmit the DevInfo data per the OMA DM protocol along with an alert containing an information (e.g., a flag value) indicating that no change has occurred to the device configuration since the last session with the server, step 414.

Thereafter, the computing device responds to the device management server commands to accomplish the update in accordance with the OMA DM protocol, step 416. Once the device management session is ended, the computing device may obtain the current update counter or current time/date, step 418, and stores the obtained value in a data record associated with the device management server, step 420. As mentioned above, the computing device may alternatively store flag values in a data table of device management servers to indicate that an intervening configuration change has been made for all but the currently accessed server. With the device management session complete, the session process 400 may end, step 422.

While the foregoing example embodiment includes the computing device sending an alert when no intervening configuration change has occurred, it should be noted that in an alternative implementation the computing device could send the alert when an intervening configuration change has occurred. Further, the information regarding the status of intervening configuration changes may be transmitted as another command or message other than the alert command used in this example. Thus, the scope of the claims should not be limited to a particular type of message or whether the message is sent to indicate the presence or absence on an intervening configuration change.

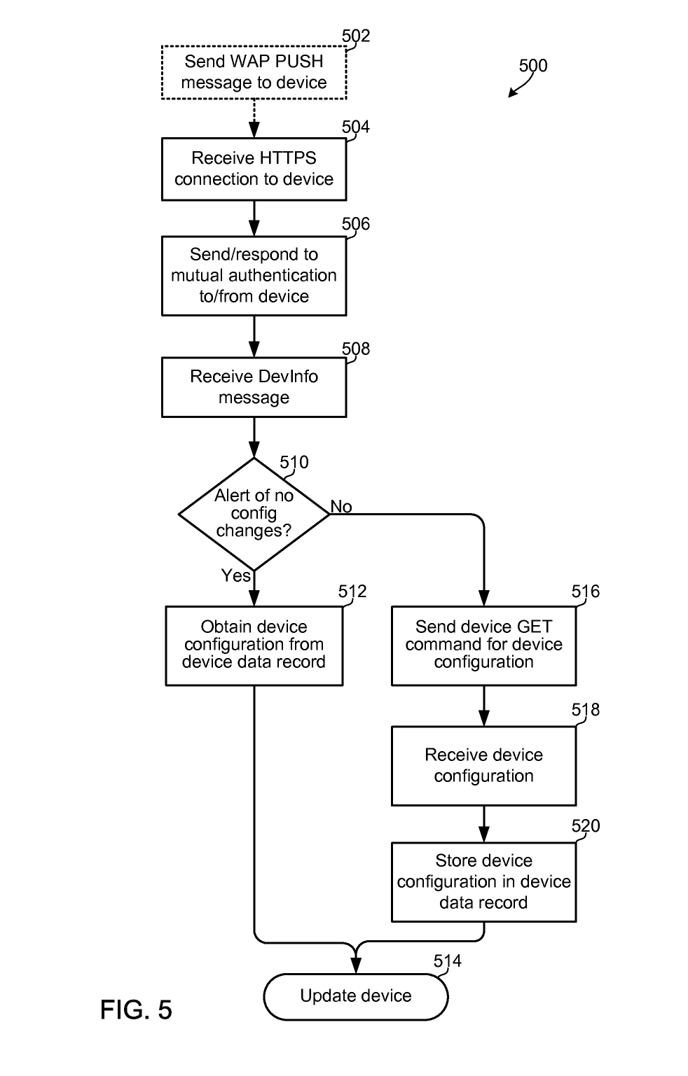

An example embodiment method 500 by which a device management server may perform an update on a remote device is illustrated in FIG. 5. The device management server may initiate an update session by sending a WAP PUSH message to the device, optional step 502. The sending of a WAP push message is optional because the computing device may initiate such a session itself However initiated, the device management server may receive a request to establish an HTTPS connection with the computing device and cooperate with the device to establish such a data connection, step 504. As part of establishing a data connection for an update session, the device management server may also send and respond to mutual authentication messages to/from the computing device, step 506.

Once the session is established, the device management server will receive the DevInfo data from the computing device, step 508. The computing device may parse the received message to determine if it includes an alert (or other message) indicating whether any intervening configuration changes have occurred, determination 510. If the received communication includes an Alert (or other type of message) indicating that no intervening configuration change has occurred (i.e. determination 510=“Yes”), the device management server may access a device configuration database to obtain device configuration data from the data record associated with the computing device, step 512. If there is no Alert or the Alert indicates that an intervening configuration change has occurred (i.e. determination 510=“No”), the device management server may send a GET command (or other command) to the computing device to obtain its configuration data, step 516. The computing device configuration data download is received, step 518, and the received information stored in a data record corresponding to the computing device within the device configuration database, step 520. With the computing device configuration data in hand, the device management server may proceed with the process of updating the computing device according to the OMA DM protocol, step 514. It should be noted that the step of storing device configuration data in the device configuration database, step 520, may be performed after the device management session complete, thereby including any changes to configuration data implemented during the session.

As mentioned above, in further embodiments the computing device may be configured to provide the device management server with more than just an indication of whether an intervening configuration change has occurred. Providing more information regarding the nature of intervening configuration changes, may enable the device management server to determine whether there is a need to download the device configuration data, thereby potentially saving communication time and bandwidth.

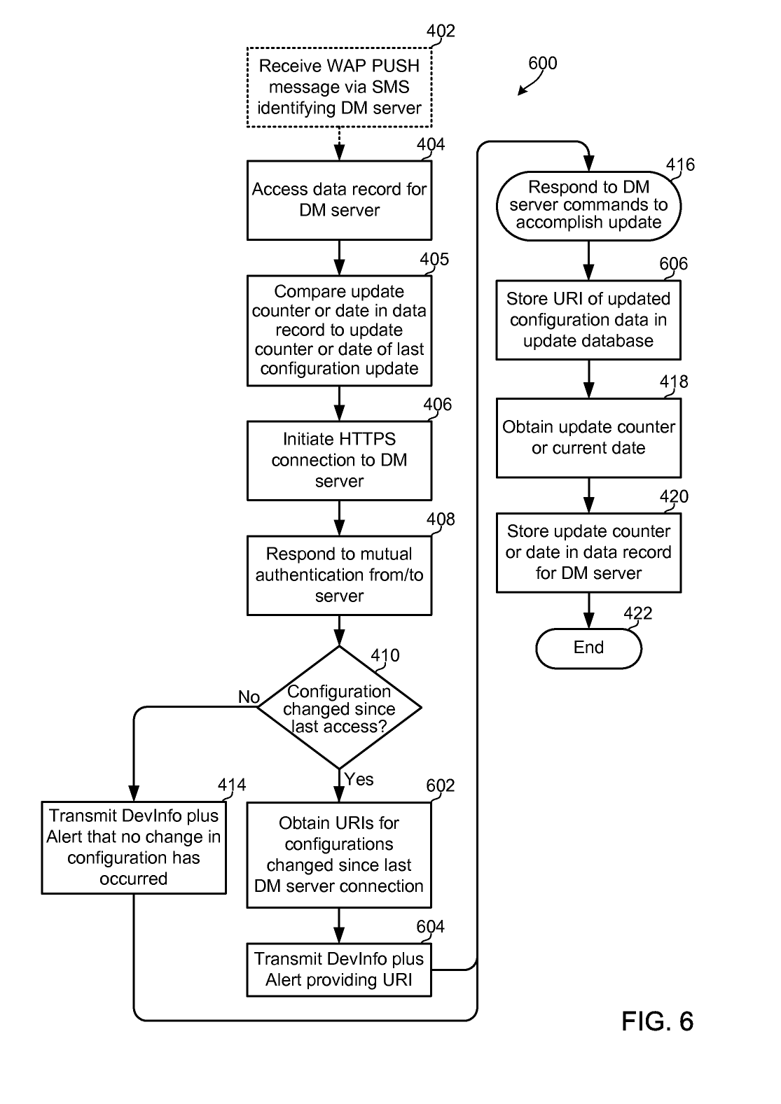

In a first alternative embodiment method 600 illustrated in FIG. 6, the computing device provides the device management server with the URI of any object or configuration item modify in an intervening configuration change. This embodiment is similar to the embodiment described above with reference to FIG. 4, so the foregoing descriptions of like numbered steps apply to FIG. 6 as well. In this embodiment, if the computing device determines that an intervening configuration change has occurred (i.e., determination 410=“Yes”), the computing device obtains the URI for each item affected by the intervening configuration change, step 602. As described below with reference to FIG. 11A, such data may be maintained in a data table which links any changed URIs to a particular configuration change update count or time/date. In such a data table, the computing device may record the URI or URIs that are modified in an update session in a data record correlated to an update counter value or time/date of the update session. With such information available in memory, the computing device can quickly determine the URIs that have been changed since the last session with the particular device management server by selecting all data records with a higher update count or a later time/date. Thus, to accomplish processes in step 602, the computing device may select each data record with a higher update count or later time/date and store the included URI(s) in a temporary memory. The computing device may then generate an Alert by including all of the URIs stored in the temporary memory.

The computing device transmits the DevInfo data along with the Alert including the obtained URI or URIs to the device management server, step 604. Similar to the embodiment described above with reference to FIG. 4, if the computing device determines that no intervening configuration change has occurred (i.e., determination 410=“No”), the configuration device may transmit the DevInfo data along with an alert indicating that there has been no intervening configuration change, step 414.

Once the DevInfo data and Alert have been transmitted (either steps 414 or 604), the computing device may respond to commands from the device management server to accomplish the update according to the OMA DM protocol, step 416. When the device management session has completed, the computing device may store the URI of each object or item for which configuration data was updated during the session in the configuration update data table, step 606. As described below with reference to FIG. 11A, such a data table may be maintained in memory of the computing device to track the update session, as may be identified by an update count or time/date of the update along with the URIs that were modified during the update session. Additionally, the computing device may obtain the current update counter value or time and date, step 418, and store this obtained information in a data record associated with the device management server, step 420. With the update session ended and the information saved, the remote update process 600 may end, step 422.

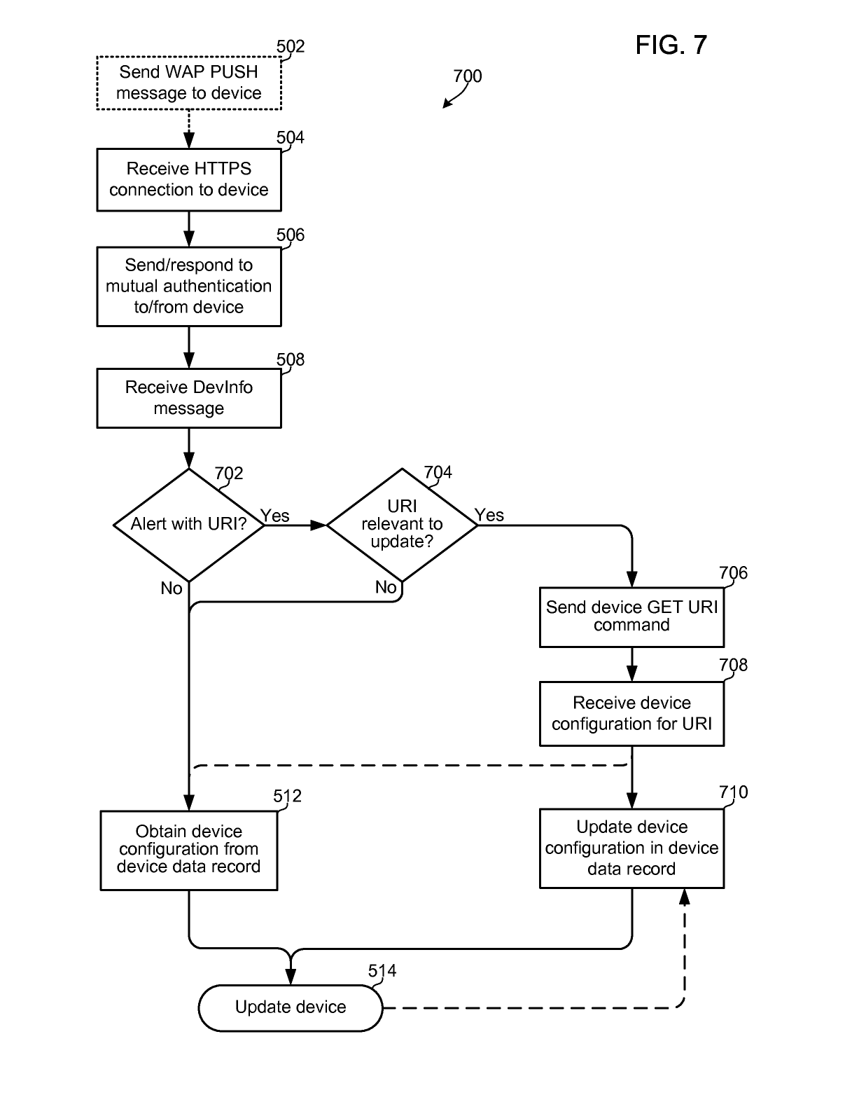

FIG. 7 illustrates an example embodiment method 700 that a device management server may implement to conduct a device management session using the URI information provided by a computing device. This embodiment is similar to the embodiment described above with reference to FIG. 5, so the foregoing descriptions of like numbered steps apply to FIG. 7 as well. When the device management server has received the DevInfo message from the computing device, step 508, the server may determine whether that communication includes an alert listing one or more URIs, determination 702. If the communication does not include a URI or the alert indicates that no intervening configuration change has occurred (i.e., determination 702=“No”), the device management server may obtain the computing device configuration data from a corresponding data record within the device configuration database, step 512. Using the obtained device configuration information, the server may proceed to update the computing device in the device management session in accordance with the OMA DM protocol, step 514.

If the Alert received from the computing device includes a URI (i.e., determination 702=“Yes”), the device management server may evaluate the URI to determine whether the particular configuration item is relevant to the pending device management task, determination 704. The URI may enable the server to determine that any changes made to the configuration data associated with that URI will not impact the pending update task. In that case (i.e., determination 704=“No”), in which case the server may skip the step of downloading configuration data from the computing device and, instead, obtain the device's configuration data from the device configuration database, step 512. This will enable the device management server to proceed with the device management session in accordance with the OMA DM protocol, step 514. In this manner, if the URI previously updated is not relevant to the pending device management task or the device management server does not interact with the specified URI, the server can avoid expending the time and bandwidth required to download configuration data from the remote computing device.

If the Alert received from the computing device includes a URI (i.e., determination 702=“Yes”), and the device management server determines that an update to the specified URI is relevant to the pending device management task (i.e., determination 704=“Yes”), the server may command the computing device to download the configuration data associated with the specified URI, step 706. This may be accomplished by issuing a GET command specifying the URI as enabled by the OMA DM protocol. The server may then receive the device configuration data for the specified URI (or URIs) from the computing device, step 708. A single GET command may be issued listing multiple URIs when more than one URI is received in the Alert. Alternatively, a series of GET commands may be issued each specifying a single URI when more than one URI is received in the Alert. Using the received configuration data, the server may update the device configuration information in the corresponding data record within the device configuration database, step 710. As part of updating the device configuration data in the device configuration database, the server may also access the other device configuration data stored in the associated data record. With the configuration data for the specified URI received, the device management server may proceed to update the computing device in the device management session in accordance with the OMA DM protocol, step 514.

As mentioned above, the step 710 of updating the device data record in the device configuration database may be accomplished after the device management session is completed so that any additional changes in configuration data implemented during the session can also be included in the database. In this alternative implementation (indicated by the dashed arrows), after (or before) the configuration data associated with the specified URI is received, step 708, the device management server can access the device configuration database to obtain the rest of the computing device configuration data, step 512. Then, using the configuration data received from the computing device and obtained from the device configuration database, the device management server can proceed with the device management session in accordance with the OMA DM protocol, step 514. Once the device management session is completed, the device management server may save the computing device's configuration data in a corresponding data record within the device configuration database, step 710.

Using the embodiment described above with reference to FIG. 7, the device management server may request the configuration data associated with a changed URI only if the configuration data associated with the specified URI is relevant to the pending device management task. In this manner, the amount of time and bandwidth expended downloading configuration data during a remote device management session can be minimized.

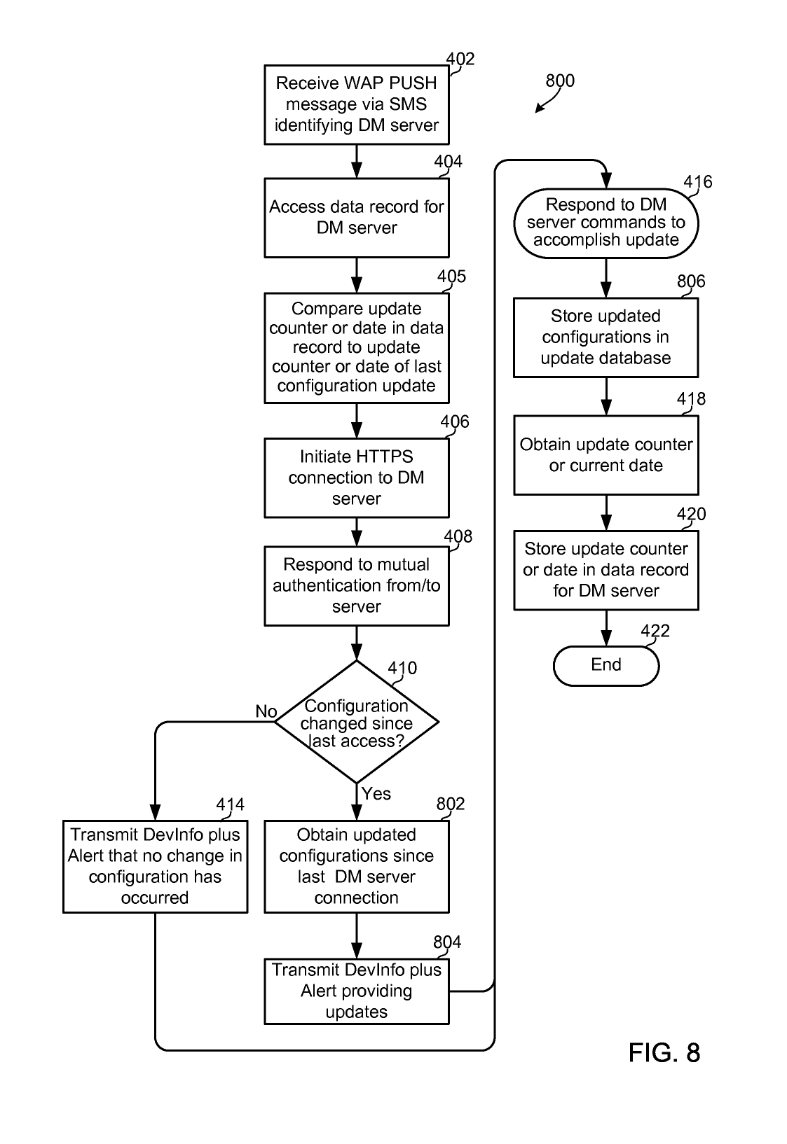

In a second alternate embodiment, if the computing device determines that an intervening configuration change occurred, the computing device forwards to the device management server the configuration data which was changed since the last session with that server. An example embodiment method 800 by which the computing device can accomplish this process is illustrated in FIG. 8. This embodiment is similar to the embodiment described above with reference to FIGS. 4 and 6, so the foregoing descriptions of like numbered steps apply to FIG. 8 as well. As described above with reference to FIG. 4, when the computing device determines that there has been no intervening configuration change (i.e. determination 410=“No”), it may transmit an Alert indicating that there has been no configuration change, step 414. However, in this embodiment, when the computing device determines that there has been an intervening configuration change (i.e., determination 410=“Yes”), the computing device may obtain the configuration data that has changed since the last device management session with the particular device management server, step 802. This information may be obtained from a database or data record stored in memory of the computing device, such as described below with reference to FIG. 11B. In such a data store, the computing device may record the configuration data that is modified in an update session correlated to an update counter value or time/date of the update session. With such information available in memory, the computing device can quickly determine the changed configuration data in all intervening configuration changes by selecting all data records with a higher update counter value or a later time/date. Thus, to accomplish processes in step 802, the computing device may select each data record with a higher update count or later time/date and store the included configuration data in a temporary memory. The computing device may then format an Alert by including all of the configuration data stored in the temporary memory. The computing device then transmits the DevInfo data along with the generated Alert to the device management server, step 804.

Once the DevInfo data and Alert have been transmitted (either steps 414 or 804), the computing device may respond to commands from the device management server to accomplish the update according to the OMA DM protocol, step 416. When the device management session has completed, the computing device may store all of the configuration data that was updated during this session in the configuration update data store or database, step 806. As described below with reference to FIG. 11B, such a data store or database may be maintained in memory of the computing device to track the update session, as may be identified by an update count or time/date of the update, along with the configuration data that were modified during the update session. Additionally, the computing device may obtain the current update counter value or time and date, step 418, and store this obtained information in a data record associated with the device management server, step 420. With the update session ended and the information saved, the remote update process 800 may end, step 422.

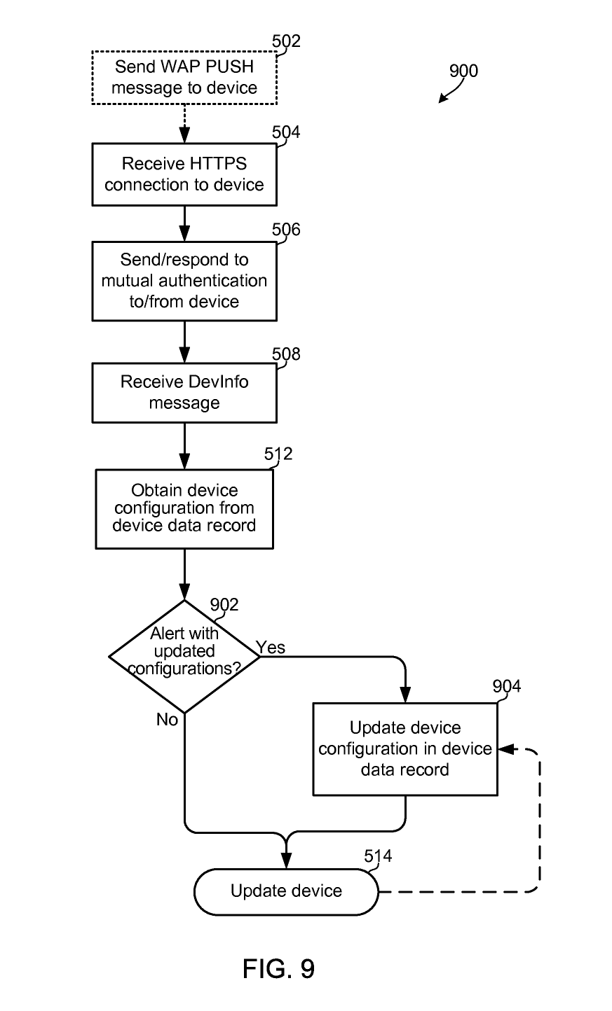

An example embodiment method 900 that a device management server may implement to conduct a device management session using the configuration data provided by a computing device is illustrated in FIG. 9. This embodiment is similar to the embodiment described above with reference to FIGS. 5 and 7, so the foregoing descriptions of like numbered steps apply to FIG. 9 as well. In this embodiment, the device management server may receive either an alert indicating that no intervening changes have been made to configuration data, or an alert containing the configuration data that has changed since the last communication session between the server and the computing device. Therefore, the device management server may obtain the device configuration data from the device configuration database, step 512, before or after receiving the DevInfo data and any Alert, step 508. The device management server may then determine whether an Alert received from the computing device includes updated configuration data, determination 902. If the communication received from the computing device does not include updated configuration data (i.e., determination 902=“No”), the server may use the device configuration data obtained from its device configuration database and immediately begin the device management session to update the remote device according to the OMA DM protocol, step 514. If the communication received on the computing device includes updated configuration data (i.e., determination 902=“No”), the server may update the device configuration data obtained from the device configuration database with the configuration data received from the computing device, step 904. Using the updated data, the device management server may proceed with the device management session to update the remote device according to the OMA DM protocol, step 514. The device management server may save the updated device configuration data in the corresponding data record in the device configuration database before updates are made to the remote computing device or after the device management session ends (as indicated by the dashed arrow).

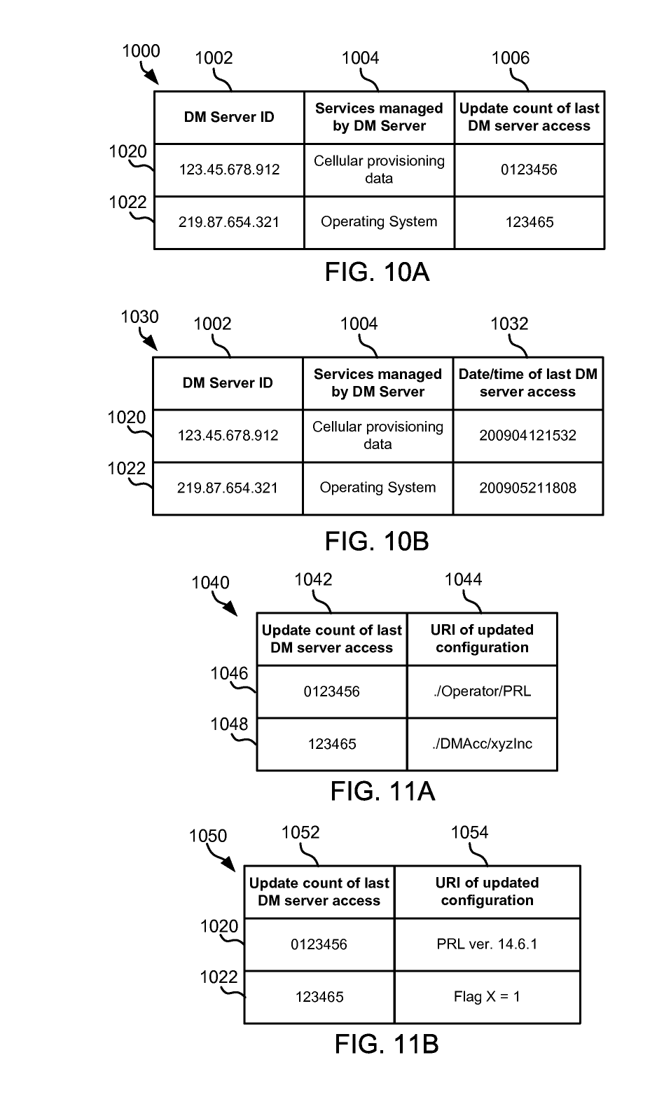

As mentioned above, the various embodiments may be implemented using a data store that records information that can enable the computing device to determine when an intervening configuration change has occurred since the last session with a particular server. FIG. 10A illustrates an example data structure for this purpose which stores the update count at the conclusion of a device management session with a particular server. Such data may be stored in a data table 1000, for example, which may include a plurality of data records 1020, 1022, each made up of a plurality of data fields (which appear as columns in the table) 1002, 1004, 1006. For example, one data field 1002 may store an identifier for a particular device management server. For example, the identifier may be the URL at which that particular server can be accessed via the Internet. Other identifiers may be used, such as server names, device IDs, or other types of network addresses. Each data record 1020, 1022 may include an update count data field 1006 for storing the update count at the conclusion of the last session with the particular device management server. When a device management session with a server is completed, the computing device may store the server's identifier in the server ID data field 1002 and store the device's update counter value in the update counter data field 1006. Then when the computing device establishes another device management session with the same server, the device can use the server's identifier (e.g., its URL) to locate the corresponding data record and obtain the update counter from the last session with the server. As shown in FIG. 10A, the data table 1000 may also include other information relevant to the server, such as a data field 1004 storing the applications or services managed by that particular server.

Another example server access data table is illustrated in FIG. 10B which stores the time and date of the conclusion of a device management session with a particular server. This example data table 1030 is similar to that described above with reference to FIG. 10A except that it includes a date/time data field 1032. When a device management session with a server is completed, the computing device may store the server's identifier (e.g., its URL) in the server ID data field 1002 and store the current time and date in the date/time data field 1032. Then when the computing device establishes another device management session with the same server, it can use the server's identifier (e.g., its URL) to locate the corresponding data record and obtain the time and date of the last session with the server.

As mentioned above, the various embodiments may be implemented using a data store or database that records the URI or URIs that are changed each time a change is made to configuration data. An example data structure 1040 for this purpose is illustrated in FIG. 11A. Such data may be stored in a data table 1040, for example, that may include a plurality of data records 1046, 1048, each made up of two or more data fields 1042, 1044. One date field 1042 may store the update counter value at the conclusion of an update to configuration data (or time/date of the update session), and another data field may store the URI of the object or item that was changed. Using this data table 1040, the computing device can quickly determine the URI or URIs affected by a particular update session by searching the table to locate the data record containing the update counter value from that session.

An alternative data structure for storing the configuration data changed in an update session is illustrated in FIG. 11B. In the illustrated example data table 1050, one date field 1052 may store the update counter value at the conclusion of an update to configuration data (or time/date of the update session), and another data field 1054 may store the configuration data that was changed. Using this data table 1050, the computing device can quickly determine the configuration data changed in a particular update session by searching the table to locate the data record containing the value of the update counter from that session.

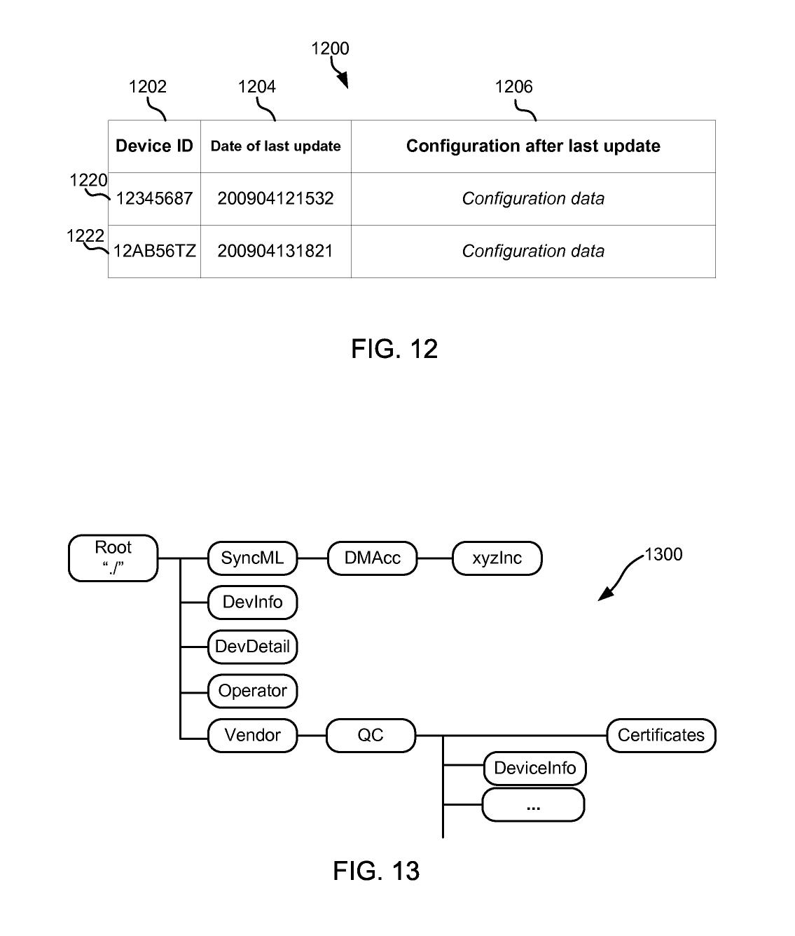

As mentioned above, the various embodiments may be implemented using a device configuration database within or accessible by the device management server that records the configuration data obtained from remote devices in each device management session. An example data structure for such a database is illustrated in FIG. 12. The illustrated example database 1200 includes a plurality of data records 1220, 1222 associated with particular remote devices, with each data record including a plurality of data fields 1202, 1204, 1206. For example, one data field 1202 in each data record may include an identifier for a particular remote device, such as a device ID. Such a device ID may be a telephone number for a cellular device, a Mac ID or URL for a networked computing device, an identifier assigned by the device management server, or some other form of device ID. Another data field 1206 may store all configuration data received from the remote computing device having the device ID listed in the device ID data field 1202. When a device management session with a remote computing device is completed, the device management server may store the device's identifier in the device ID data field 1202 and store the device's configuration data in the configuration data field 1206. Then when the device management server establishes another device management session with a remote computing device, it can use the device's identifier, such as may be received in the DevInfo data, to locate the corresponding data record within the device configuration database 1200 and obtain the device's configuration data from the configuration data field 1206. As shown in FIG. 12, the database 1200 may also include other information relevant to managing remote devices, such as a date data field 1204 storing the time and date of the last device management session with a particular device (i.e., the device with the ID listed in the device ID data field 1202).

It is worth noting that in the OMA DM protocol, the computing device generates a device management tree of URIs at the time a device management session is initiated. An example of a device management tree is illustrated in FIG. 13. In the context of OMA DM, a remote computing device can be viewed as a hierarchical tree structure where the interior nodes and leaf nodes of the tree are the device settings and the leaf node values are the device setting values. The device management server can configure the remote computing device by manipulating the nodes, i.e., changing configuration data. The server can access a node by specifying its URI, which is a hierarchical path to the node starting from the root “./”. Nodes are entities that the server can manipulate through the OMA DM protocol. An interior node can have an unlimited number of child nodes, while a leaf node must contain a value, including null. Each node has a set of run-time properties or configuration data associated with it. All properties are only valid for the associated node, except the Access Control List (ACL). A node's ACL identifies the device management server or servers which can manipulate that node. ACLs apply to the current node as well as child nodes, until a child node has an ACL set differently. The device management tree generated for an update session will include only those URIs of relevance to the particular device management server. The device management tree may be communicated to the device management server as part of the session initiation process or may be known to the device management server.

The various embodiments may be implemented by programming servers and computing devices to add the additional processing are described herein. This may be accomplished by revising the OMA DM protocol to permit one or more of the embodiment methods.

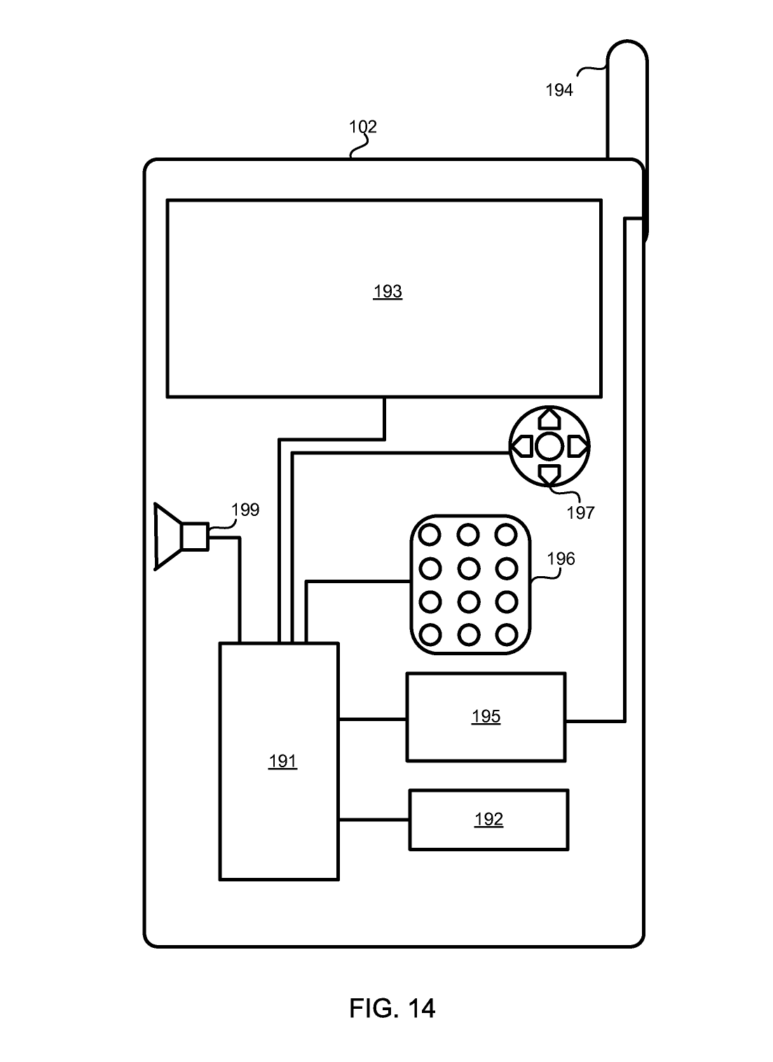

Computing devices which may benefit from the various embodiments may include computing devices with access to a network including a remote device maintenance server, such as a mobile device 102 or personal computer 103. Mobile devices 102, such as cellular telephones, may particularly benefit from the various embodiments due to the typically slower data transmission rate of wireless communication networks. Typical mobile devices 102 suitable for use with the various embodiments will have in common the components illustrated in FIG. 14. For example, an exemplary mobile device 102 may include a processor 191 coupled to internal memory 192, and a display 193. Additionally, the mobile device 102 may have an antenna 194 for sending and receiving electromagnetic radiation that is connected to a wireless data link and/or cellular telephone transceiver 195 coupled to the processor 191. Mobile devices typically also include a key pad 196 or miniature keyboard and menu selection buttons or rocker switches 197 for receiving user inputs.

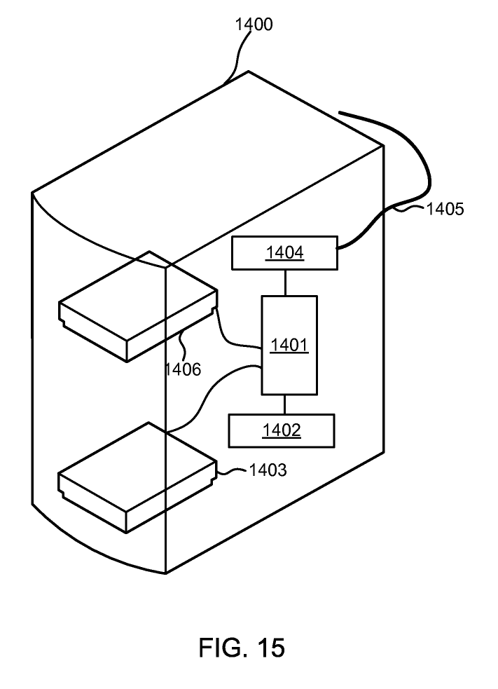

The embodiments described above may be implemented with any of a variety of server devices, such as the server 1400 illustrated in FIG. 15. Such a server 1400 typically includes a processor 1401 coupled to volatile memory 1402 and a large capacity nonvolatile memory, such as a hard disk drive 1403. The server 1400 may also include a floppy disc drive and/or a compact disc (CD) drive 1406 coupled to the processor 1401. The server 1400 may also include network access ports 1404 coupled to the processor 1401 for establishing data connections with network circuits 1405, such as the Internet. The hard disk drive 1403 may include sufficient storage to host the device configuration database used in the various embodiments. Alternatively, the device configuration database may be hosted on a separate disk drive (not shown) such as may be accessed by the server 1400 via a network 1405.

The processors 191, 1401 in the various devices may be any programmable microprocessor, microcomputer or multiple processor chip or chips that can be configured by software instructions (applications) to perform a variety of functions, including the functions of the various embodiments described herein. In some devices, multiple processors 191, 1401 may be provided, such as one processor dedicated to wireless communication functions and one processor dedicated to running other applications. Typically, software applications may be stored in the internal memory 19 1402 before they are accessed and loaded into the processor 191, 1401. In some mobile devices, the processor 191, 1401 may include internal memory sufficient to store the application software instructions. In some devices, the secure memory may be in a separate memory chip coupled to the processor 191, 1401. In many devices the internal memory 192, 1402 may be a volatile or nonvolatile memory, such as flash memory, or a mixture of both. For the purposes of this description, a general reference to memory refers to all memory accessible by the processor 191, 1401, including internal memory 192, 1402, removable memory plugged into the device, and memory within the processor 191, 1401 itself

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Similarly, the order in which elements are recited in claims are arbitrary and do not imply that such elements must be performed in the order presented. For example, determining whether an intervening configuration change has occurred since a last communication with a device management server may be accomplished by a computing device before or after initiating a device management session or establishing a communication link to a server. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored on or transmitted over as one or more instructions or code on a computer-readable medium. The steps of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein. what is claimed is:

1. A method for performing a device management process on a computing device from a device management server, comprising:
establishing a communication link between the computing device and the device management server;
determining whether any computing device configuration data have been changed since a last time a communication link was established between the computing device and the device management server; and
transmitting a message to the device management server indicating that there have been no intervening configuration data changes when it is determined that no configuration data have been changed since a last time a communication link was established between the computing device and the device management server.

2. The method of claim 1, further comprising:
determining whether a message indicating that there have been no intervening configuration data changes is received from the computing device;
obtaining configuration data for the computing device from a device configuration database when it is determined that a message has been received from the computing device indicating that there have been no intervening configuration data changes; and
accomplishing a device management process on the computing device based on the configuration data obtained from the device configuration database.

3. The method of claim 2, wherein the device configuration database comprises a data record corresponding to the computing device including a data field storing the computing device configuration data.

4. The method of claim 3, further comprising:
updating the device configuration database with changed configuration data after the device management process is completed.

5. The method of claim 1, wherein determining whether any computing device configuration data have been changed since a last time a communication link was established between the computing device and the device management server is accomplished using data stored in memory of the computing device related to the last time a communication link was established between the computing device and the device management server.

6. The method of claim 1, further comprising:
accessing a data record stored in memory of the computing device to obtain an update count corresponding to a last time a communication link was established between the computing device and the device management server,
wherein determining whether any computing device configuration data have been changed since a last time a communication link was established between the computing device and the device management server comprises comparing the obtained update count to a current update count.

7. The method of claim 1, further comprising:
accessing a data record stored in memory of the computing device to obtain date of a last time a communication link was established between the computing device and the device management server; and
accessing a data record stored in memory to obtain a date of a last change to configuration data,
wherein determining whether any computing device configuration data have been changed since a last time a communication link was established between the computing device and the device management server comprises comparing the obtained date of the last communication link with the device management server to the obtained date of the last change to configuration data.

8. A method of claim 1, further comprising:
accessing a data record stored in memory of the computing device to obtain a universal resource indicator (URI) of an item affected by an intervening configuration data change when it is determined that configuration data have been changed since the last time a communication link was established between the computing device and the device management server; and
transmitting a message including the obtained URI to the device management server when it is determined that configuration data have been changed since the last time a communication link was established between the computing device and the device management server.

9. The method of claim 8, further comprising:
determining whether a message including a URI is received from the computing device;
obtaining configuration data corresponding to the URI by transmitting a data request message to the computing device when it is determined that a message including a URI is received from the computing device;
obtaining configuration data for the computing device from the device configuration database when it is determined that a message including a URI is received from the computing device; and
accomplishing the device management process on the computing device based on the configuration data obtained from the computing device and the device configuration database.

10. The method of claim 8, further comprising storing in memory of the computing device a URI of an item affected by the device management process correlated to a current update counter value.

11. The method of claim 8, further comprising storing in memory of the computing device a URI of an item affected by the device management process correlated to a current date.

12. A method of claim 1, further comprising:
accessing a data record stored in memory of the computing device to obtain changed configuration data when it is determined that configuration data have been changed since the last time a communication link was established between the computing device and the device management server; and
transmitting a message including the changed configuration data to the device management server when it is determined that configuration data have been changed since the last time a communication link was established between the computing device and the device management server.

13. The method of claim 12, further comprising:
determining whether a message including changed configuration data is received from the computing device;
obtaining configuration data for the computing device from the device configuration database when it is determined that a message including changed configuration data is received from the computing device; and
accomplishing the device management process on the computing device based on a combination of the configuration data received from the computing device and the configuration data obtained from the device configuration database.

14. The method of claim 12, further comprising storing in memory of the computing device configuration data changed by the device management process correlated to a current update counter value.

15. The method of claim 12, further comprising storing in memory of the computing device configuration data changed by the device management process correlated to a current date.

16. A computing device, comprising:
a processor;
a memory coupled to the processor; and
a transceiver coupled to the processor and configured to establish a network connection by which the processor can communicate via a network,
wherein the processor is configured with processor-executable instructions to perform steps comprising:
establishing a communication link via the transceiver between the computing device and a device management server;
determining whether any computing device configuration data have been changed since a last time a communication link was established between the computing device and the device management server; and
transmitting a message to the device management server indicating that there have been no intervening configuration data changes when it is determined that no configuration data have been changed since a last time a communication link was established between the computing device and the device management server.

17. The computing device of claim 16, wherein the processor is further configured by processor-executable instructions such that determining whether any computing device configuration data have been changed since a last time a communication link was established between the computing device and the device management server comprises using data stored in the memory related to the last time a communication link was established between the computing device and the device management server.

18. The computing device of claim 16, wherein the processor is further configured by processor-executable instructions to perform steps further comprising:
accessing a data record stored in the memory to obtain an update count corresponding to a last time a communication link was established between the computing device and the device management server,
wherein the processor is further configured by processor-executable instructions such that determining whether any computing device configuration data have been changed since a last time a communication link was established between the computing device and the device management server comprises comparing the obtained update count to a current update count.

19. The computing device of claim 16, wherein the processor is further configured by processor-executable instructions to perform steps further comprising:
accessing a data record stored in the memory to obtain date of a last time a communication link was established between the computing device and the device management server; and
accessing a data record stored in the memory to obtain a date of a last change to configuration data,
wherein the processor is further configured by processor-executable instructions such that determining whether any computing device configuration data have been changed since a last time a communication link was established between the computing device and the device management server comprises comparing the obtained date of the last communication link with the device management server to the obtained date of the last change to configuration data.

20. A computing device, comprising:
a processor;
a memory coupled to the processor; and
a transceiver coupled to the processor and configured to establish a network connection by which the processor can communicate via a network,
wherein the processor is configured with processor-executable instructions to perform steps comprising:
accessing a data record stored in the memory to obtain a universal resource indicator (URI) of an item affected by an intervening configuration data change when it is determined that configuration data have been changed since the last time a communication link was established between the computing device and a device management server; and
transmitting a message including the obtained URI to the device management server when it is determined that configuration data have been changed since the last time a communication link was established between the computing device and the device management server.

21. The computing device of claim 20, wherein the processor is configured with processor-executable instructions to perform further steps comprising storing in the memory a URI of an item affected by the device management process correlated to a current update counter value.

22. The computing device of claim 20, wherein the processor is configured with processor-executable instructions to perform further steps comprising storing in the memory a URI of an item affected by the device management process correlated to a current date.

23. A computing device, comprising:
a processor;
a memory coupled to the processor; and
a transceiver coupled to the processor and configured to establish a network connection by which the processor can communicate via a network,
wherein the processor is configured with processor-executable instructions to perform steps comprising:
accessing a data record stored in the memory to obtain changed configuration data when it is determined that configuration data have been changed since the last time a communication link was established between the computing device and a device management server; and
transmitting a message including the changed configuration data to the device management server when it is determined that configuration data have been changed since the last time a communication link was established between the computing device and the device management server.

24. The computing device of claim 23, wherein the processor is configured with processor-executable instructions to perform further steps comprising storing in the memory configuration data changed by the device management process correlated to a current update counter value.

25. The computing device of claim 23, wherein the processor is configured with processor-executable instructions to perform further steps comprising storing in the memory configuration data changed by the device management process correlated to a current date.

26. A server, comprising:
a processor;
a memory coupled to the processor; and
a transceiver coupled to the processor and configured to establish a network connection by which the processor can communicate via a network,
wherein the processor is configured with processor-executable instructions to perform steps comprising:
establishing a communication link between the server and a remote computing device;
receiving a message from the remote computing device;
determining whether the received message indicates that there have been no intervening configuration data changes in the remote computing device;
obtaining configuration data for the remote computing device from a device configuration database stored in the memory when it is determined that the received message indicates that there have been no intervening configuration data changes in the remote computing device; and
accomplishing a device management process on the remote computing device based on the configuration data obtained from the device configuration database.

27. The server of claim 26, wherein the device configuration database comprises a data record corresponding to the remote computing device including a data field storing the computing device configuration data.

28. The server of claim 27, wherein the processor is configured with processor-executable instructions to perform steps further comprising:
updating the device configuration database with changed configuration data after the device management process is completed.

29. The server of claim 27, wherein the processor is configured with processor-executable instructions to perform steps further comprising:
determining whether the received message includes a URI;
obtaining configuration data corresponding to the URI by transmitting a data request message to the computing device when it is determined that a message including a URI is received from the computing device;
obtaining configuration data for the computing device from the device configuration database when it is determined that a message including a URI is received from the computing device; and
accomplishing the device management process on the computing device based on the configuration data obtained from the computing device and the device configuration database.

30. The server of claim 27, wherein the processor is configured with processor-executable instructions to perform steps further comprising:
determining whether the received message includes changed configuration data;
obtaining configuration data for the computing device from the device configuration database when it is determined that a message including changed configuration data is received from the computing device; and
accomplishing the device management process on the computing device based on a combination of the configuration data received from the computing device and the configuration data obtained from the device configuration database.

31. A system, comprising:
a computing device coupled to a communication network; and
a device management server coupled to the communication network and configured to perform remote device maintenance on the computing device,
wherein the computing device comprises:
a processor;
a memory coupled to the processor; and
a transceiver coupled to the processor and configured to communicate via the communication network,
wherein the processor is configured with processor-executable instructions to perform steps comprising:
establishing a communication link via the transceiver between the computing device and the device management server;
determining whether any computing device configuration data have been changed since a last time a communication link was established between the computing device and the device management server; and
transmitting a message to the device management server indicating that there have been no intervening configuration data changes when it is determined that no configuration data have been changed since a last time a communication link was established between the computing device and the device management server, and
wherein the device management server comprises:
a server processor;
a server memory coupled to the processor, the server memory having stored thereon a device configuration database; and
a network interface circuit coupled to the server processor and configured to enable the server processor to communicate via the communication network,
wherein the server processor is configured with processor-executable instructions to perform steps comprising:
receiving the message from the computing device;
determining whether the received message indicates that there have been no intervening configuration data changes in the computing device;
obtaining configuration data for the computing device from the device configuration database stored in the server memory when it is determined that the received message indicates that there have been no intervening configuration data changes in the computing device; and
accomplishing a device management process on the computing device based on the configuration data obtained from the device configuration database.

32. The system of claim 31,
wherein the computing device processor is configured with processor-executable instructions to perform further steps comprising:
accessing a data record stored in the memory to obtain a universal resource indicator (URI) of an item affected by an intervening configuration data change when it is determined that configuration data have been changed since the last time a communication link was established between the computing device and the device management server; and
including the obtained URI in the message transmitted to the device management server when it is determined that configuration data have been changed since the last time a communication link was established between the computing device and the device management server, and
wherein the server processor is configured with processor-executable instructions to perform steps further comprising:
determining whether the received message includes a URI;
obtaining configuration data corresponding to the URI by transmitting a data request message to the computing device when it is determined that a message including a URI is received from the computing device;
obtaining configuration data for the computing device from the device configuration database when it is determined that a message including a URI is received from the computing device; and
accomplishing the device management process on the computing device based on the configuration data obtained from the computing device and the device configuration database.

33. The system of claim 31,
wherein the computing device processor is configured with processor-executable instructions to perform further steps comprising:
accessing a data record stored in the memory to changed configuration data affected by an intervening configuration data change when it is determined that configuration data have been changed since the last time a communication link was established between the computing device and the device management server; and
including the changed configuration data in the message to the device management server when it is determined that configuration data have been changed since the last time a communication link was established between the computing device and the device management server, and
wherein the server processor is configured with processor-executable instructions to perform steps further comprising:
determining whether the received message includes changed configuration data;
obtaining configuration data for the computing device from the device configuration database when it is determined that a message including changed configuration data is received from the computing device; and
accomplishing the device management process on the computing device based on a combination of the configuration data received from the computing device and the configuration data obtained from the device configuration database.

34. A computing device, comprising:
means for establishing a communication link between the computing device and a device management server;
means for determining whether any computing device configuration data have been changed since a last time a communication link was established between the computing device and the device management server; and
means for transmitting a message to the device management server indicating that there have been no intervening configuration data changes when it is determined that no configuration data have been changed since a last time a communication link was established between the computing device and the device management server.

35. The computing device of claim 34, wherein means for determining whether any computing device configuration data have been changed since a last time a communication link was established between the computing device and the device management server comprises means for using data stored in the memory related to the last time a communication link was established between the computing device and the device management server.

36. The computing device of claim 34, further comprising:
means for accessing a data record stored in the memory to obtain an update count corresponding to a last time a communication link was established between the computing device and the device management server,
wherein means for determining whether any computing device configuration data have been changed since a last time a communication link was established between the computing device and the device management server comprises means for comparing the obtained update count to a current update count.

37. The computing device of claim 34, further comprising:
means for accessing a data record stored in the memory to obtain date of a last time a communication link was established between the computing device and the device management server; and
means for accessing a data record stored in the memory to obtain a date of a last change to configuration data,
wherein means for determining whether any computing device configuration data have been changed since a last time a communication link was established between the computing device and the device management server comprises means for comparing the obtained date of the last communication link with the device management server to the obtained date of the last change to configuration data.

38. A computing device, comprising:
means for accessing a data record stored in the memory to obtain a universal resource indicator (URI) of an item affected by an intervening configuration data change when it is determined that configuration data have been changed since the last time a communication link was established between the computing device and a device management server; and
means for transmitting a message including the obtained URI to the device management server when it is determined that configuration data have been changed since the last time a communication link was established between the computing device and the device management server.

39. The computing device of claim 38, further comprising means for storing a URI of an item affected by the device management process correlated to a current update counter value.

40. The computing device of claim 38, further comprising means for storing a URI of an item affected by the device management process correlated to a current date.

41. A computing device, comprising:
means for accessing a data record stored in the memory to obtain changed configuration data when it is determined that configuration data have been changed since the last time a communication link was established between the computing device and a device management server; and
means for transmitting a message including the changed configuration data to the device management server when it is determined that configuration data have been changed since the last time a communication link was established between the computing device and the device management server.

42. The computing device of claim 41, further comprising means for storing configuration data changed by the device management process correlated to a current update counter value.

43. The computing device of claim 41, further comprising means for storing configuration data changed by the device management process correlated to a current date.

44. A server, comprising:
means for establishing a communication link between the server and a remote computing device;
means for receiving a message from the remote computing device;
means for determining whether the received message indicates that there have been no intervening configuration data changes in the remote computing device;
means for obtaining configuration data for the remote computing device from a device configuration database stored in the memory when it is determined that the received message indicates that there have been no intervening configuration data changes in the remote computing device; and
means for accomplishing a device management process on the remote computing device based on the configuration data obtained from the device configuration database.

45. The server of claim 44, wherein the device configuration database comprises a data record corresponding to the remote computing device including a data field storing the computing device configuration data.

46. The server of claim 45, further comprising:
means for updating the device configuration database with changed configuration data after the device management process is completed.

47. The server of claim 45, further comprising:
means for determining whether the received message includes a URI;
means for obtaining configuration data corresponding to the URI by transmitting a data request message to the computing device when it is determined that a message including a URI is received from the computing device;
means for obtaining configuration data for the computing device from the device configuration database when it is determined that a message including a URI is received from the computing device; and
means for accomplishing the device management process on the computing device based on the configuration data obtained from the computing device and the device configuration database.

48. The server of claim 45, further comprising:
means for determining whether the received message includes changed configuration data;
means for obtaining configuration data for the computing device from the device configuration database when it is determined that a message including changed configuration data is received from the computing device; and
means for accomplishing the device management process on the computing device based on a combination of the configuration data received from the computing device and the configuration data obtained from the device configuration database.

49. A computer program product, comprising:
a computer readable storage medium comprising:
at least one instruction for establishing a communication link via the transceiver between a computing device and a device management server;
at least one instruction for determining whether any computing device configuration data have been changed since a last time a communication link was established between the computing device and the device management server; and
at least one instruction for transmitting a message to the device management server indicating that there have been no intervening configuration data changes when it is determined that no configuration data have been changed since a last time a communication link was established between the computing device and the device management server.

50. The computer program product of claim 49, wherein the computer readable storage medium further comprises:
at least one instruction for accessing a data record stored in the memory to obtain an update count corresponding to a last time a communication link was established between the computing device and the device management server,
wherein the at least one instruction for determining whether any computing device configuration data have been changed since a last time a communication link was established between the computing device and the device management server comprises at least one instruction for comparing the obtained update count to a current update count.

51. The computer program product of claim 49, wherein the computer readable storage medium further comprises:
at least one instruction for accessing a data record stored in the memory to obtain date of a last time a communication link was established between the computing device and the device management server; and
at least one instruction for accessing a data record stored in the memory to obtain a date of a last change to configuration data,
wherein the at least one instruction for determining whether any computing device configuration data have been changed since a last time a communication link was established between the computing device and the device management server comprises at least one instruction for comparing the obtained date of the last communication link with the device management server to the obtained date of the last change to configuration data.

52. A computer program product, comprising:
a computer readable storage medium comprising:
at least one instruction for accessing a data record stored in the memory to obtain a universal resource indicator (URI) of an item affected by an intervening configuration data change when it is determined that configuration data have been changed since the last time a communication link was established between the computing device and a device management server; and
at least one instruction for transmitting a message including the obtained URI to the device management server when it is determined that configuration data have been changed since the last time a communication link was established between the computing device and the device management server.

53. The computer program product of claim 52, wherein the computer readable storage medium further comprises at least one instruction for storing in the memory a URI of an item affected by the device management process correlated to a current update counter value.

54. The computer program product of claim 52, wherein the computer readable storage medium further comprises at least one instruction for storing in the memory a URI of an item affected by the device management process correlated to a current date.

55. A computer program product, comprising:
a computer readable storage medium comprising:
at least one instruction for accessing a data record stored in the memory to obtain changed configuration data when it is determined that configuration data have been changed since the last time a communication link was established between the computing device and a device management server; and
transmitting a message including the changed configuration data to the device management server when it is determined that configuration data have been changed since the last time a communication link was established between the computing device and the device management server.

56. The computer program product of claim 55, wherein the computer readable storage medium further comprises at least one instruction for storing in the memory configuration data changed by the device management process correlated to a current update counter value.

57. The computer program product of claim 55, wherein the computer readable storage medium further comprises at least one instruction for storing in the memory configuration data changed by the device management process correlated to a current date.

58. A computer program product, comprising:
a computer readable storage medium comprising:
at least one instruction for establishing a communication link between a server and a remote computing device;
at least one instruction for receiving a message from the remote computing device;
at least one instruction for determining whether the received message indicates that there have been no intervening configuration data changes in the remote computing device;
at least one instruction for obtaining configuration data for the remote computing device from a device configuration database stored in the memory when it is determined that the received message indicates that there have been no intervening configuration data changes in the remote computing device; and
at least one instruction for accomplishing a device management process on the remote computing device based on the configuration data obtained from the device configuration database.

59. The computer program product of claim 58, wherein the computer readable storage medium further comprises at least one instruction for accessing within the device configuration database a data record corresponding to the remote computing device including a data field storing the computing device configuration data.

60. The computer program product of claim 59, wherein the computer readable storage medium further comprises at least one instruction for updating the device configuration database with changed configuration data after the device management process is completed.

61. The computer program product of claim 60, wherein the computer readable storage medium further comprises:
at least one instruction for determining whether the received message includes a URI;
at least one instruction for obtaining configuration data corresponding to the URI by transmitting a data request message to the computing device when it is determined that a message including a URI is received from the computing device;
at least one instruction for obtaining configuration data for the computing device from the device configuration database when it is determined that a message including a URI is received from the computing device; and
at least one instruction for accomplishing the device management process on the computing device based on the configuration data obtained from the computing device and the device configuration database.

62. The computer program product of claim 60, wherein the computer readable storage medium further comprises:
at least one instruction for determining whether the received message includes changed configuration data;
at least one instruction for obtaining configuration data for the computing device from the device configuration database when it is determined that a message including changed configuration data is received from the computing device; and
at least one instruction for accomplishing the device management process on the computing device based on a combination of the configuration data received from the computing device and the configuration data obtained from the device configuration database.
